(19) United States
(12) Patent Application Publication
(10) Pub. No.: US 2011/0051430 A1
(43) Pub. Date: Mar. 3, 2011

(54) ASSEMBLY STRUCTURE FOR LED FIXTURE

(76) Inventor: Shih-Ming CHEN, Yingge Township (TW)

(21) Appl. No.: 12/546,768

(22) Filed: Aug. 25, 2009

(51) Int. Cl. F21V 29/00

(52) U.S. Cl. 362/373

(57) ABSTRACT

An assembly structure for LED fixture includes a cooling body, a thermally conductive body and an LED module. The cooling body includes a cylinder, a center of which has a central hole; the thermally conductive body is arranged an opening and a plurality of sectional grooves, each of which is elastically deformed to make the thermally conductive body forcedly arranged into the central hole and thermally contacted with the cylinder; the LED module is connected by passing through the opening of the thermally conductive body and includes a seat body, an LED fixed to the seat body and a thermally conductive piece fitted onto the seat body and thermally contacted with the thermally conductive body; thereby, they are easily placed into the central hole of the cooling body with a capability to achieve effects of close combination and excellent contact between each constituent components.

### BACKGROUND OF THE INVENTION

1. Field of the Invention

The present invention in general relates to an assembly structure, in particular, to an assembly structure for LED fixture.

2. Description of Prior Art

Among a variety of lighting components, since of the merits of superior lightness, longer lifespan and less power consumption, light-emitting diode (LED) has been comprehensively applied in a large amount of fixtures used indoors or outdoors. There are two critical factors deciding the winning or losing of these kinds of fixtures; namely, the consideration of cost and the solution of cooling problem. Therefore, taking these requirements as study issues, the inventor undergoes an innovative design embodied as the present invention.

According to prior arts, an LED fixture mainly includes a cooling body, a thermally conductive block and an LED. The bottom face of the LED is directly attached onto the thermally conductive block, which is then interconnected with the cooling body. In order to increase the thermally conductive and cooling efficiencies of this kind of LED fixture, the thermally conductive block is usually contacted with the cooling body closely. In addition, in order to make the thermally conductive block contacted closely with the cooling body, in general, the thermally conductive block is tightly matched with the cooling body by insetting therein. Coating thermally conductive paste between the thermally conductive block and the cooling body is also an alternative, which can increase the thermally conductive efficiency between each other.

However, there are still a lot of drawbacks existing for this kind of LED fixture in terms of practical uses. In order to pursue a tight (or excessive) match between the thermally conductive block and the cooling body, if insetting the thermally conductive block directly into the cooling body, not only the assembly difficulty is higher, but also a secondary machining is needed for most of the thermally conductive block or the cooling body, which derives an additional cost because of the secondary machining. Furthermore, if it is necessary to take the thermally conductive block from the interior of the cooling body, its difficulty is even higher. Usually, a destructive manner is needed to dismantle or separate both components. Besides, if the bottom face of the LED is directly attached onto the thermally conductive block to undergo a thermally conductive and cooling process, it will be restricted by the limitation of contacting area, making the heat generated from the LED unable to be dissipated quickly and in large amount, which is an issue needed to be addressed urgently.

Accordingly, after a substantially devoted study, in cooperation with the application of relative academic principles, the inventor has finally proposed the present invention that is designed reasonably to possess the capability to improve the drawbacks of the prior art significantly.

### SUMMARY OF THE INVENTION

Therefore, in order to solve aforementioned problems, the invention is mainly to provide an assembly structure for LED fixture, in which a thermally conductive body can generate elastic deformations of contraction and expansion, by which the thermally conductive body is easily placed into a central hole of a cooling body, being able to achieve effects of close combination and excellent contact between each constituent components.

Secondary, the invention is to provide an assembly structure for LED fixture, including a cooling body, a thermally conductive body and an LED module. According to the invention, the cooling body includes a cylinder, a center of which has a central hole; the thermally conductive body is arranged an opening and a plurality of sectional grooves, each of which is elastically deformed to make the thermally conductive body forcedly arranged into the central hole and thermally contacted with the cylinder; the LED module is connected by passing through the opening of the thermally conductive body and includes a seat body, an LED fixed to the seat body and a thermally conductive piece fitted onto the seat body and thermally contacted with the thermally conductive body.

Thirdly, the invention is to provide an assembly structure for LED fixture, in which a thermally conductive body and an LED module are forcedly placed into a central hole of a cooling body, being able to achieve effects of close combination and excellent contact between each constituent components.

Fourthly, the invention is to provide an assembly structure for LED fixture, including a cooling body, a thermally conductive body and an LED module. According to the invention, the cooling body includes a cylinder, a center of which has a central hole; the thermally conductive body forcedly arranged into the central hole and thermally contacted with the cylinder has an opening at a center thereof, the LED module is connected by passing through the opening of the thermally conductive body and includes a seat body, an LED fixed to the seat body and a thermally conductive piece fitted onto the seat body and thermally contacted with the thermally conductive body.

By comparing with prior arts, the invention has following functions. Since groove gaps are arranged in the thermally conductive body, it is easy for the LED module to be placed into the opening of the thermally conductive body, achieving a close combination and enhancing a thermally conductive effect between each constituent components. Furthermore, because of a wedging-and-clamping function existing between each pair of protrusive rail and position stripe, it can avoid a rotation phenomenon occurred between each other. In addition, by arranging insetting grooves separately shown as a ring shape in the cylinder, the cooling fins can be disposed in a radial and more intensive manner, thus, enhancing the cooling performance entirely.

### BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

FIG. 1 is a perspective explosive illustration of the first embodiment according to the present invention;

FIG. 2 is an assembled illustration of the first embodiment according to the present invention;

FIG. 3 is a cross-sectional illustration of FIG. 2;

FIG. 4 is a longitudinally sectional illustration of FIG. 2;

FIG. 5 is a perspective explosive illustration of the second embodiment according to the present invention;

FIG. 6 is a cross-sectional illustration of FIG. 5;

FIG. 7 is a longitudinally sectional illustration of the third embodiment according to the present invention;

FIG. 8 is a cross-sectional illustration of the fourth embodiment according to the present invention; and

FIG. 9 is a cross-sectional illustration of the fifth embodiment according to the present invention.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

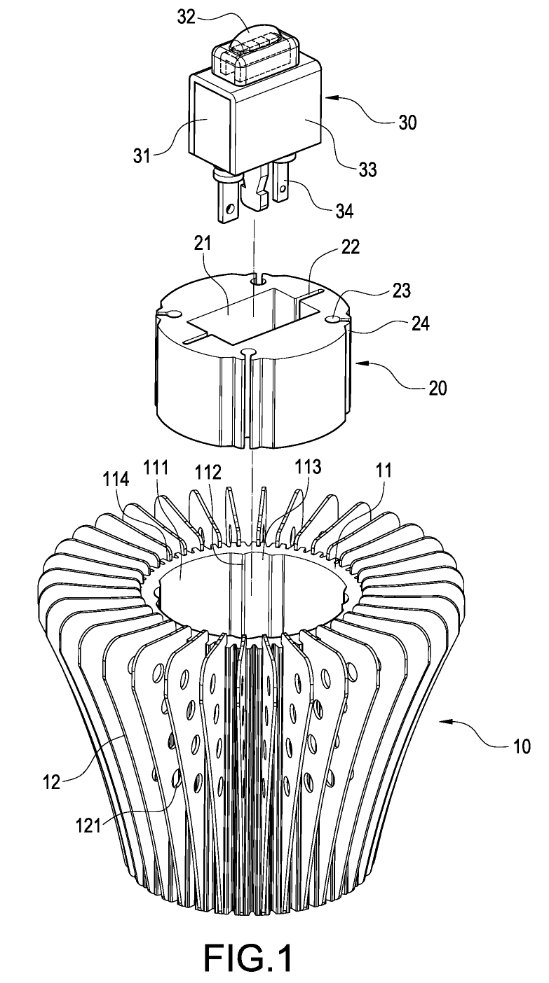

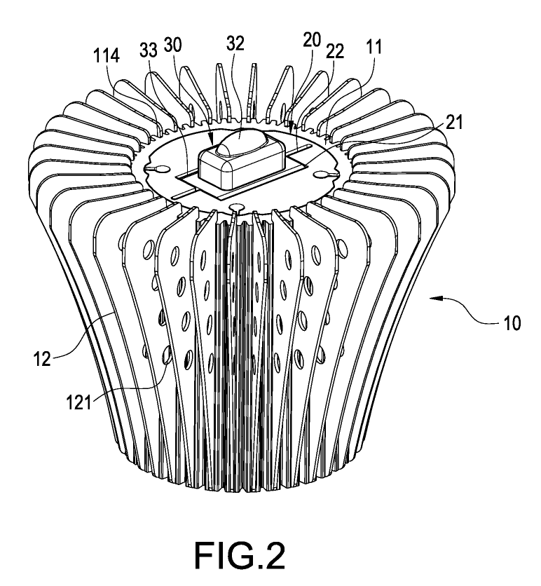

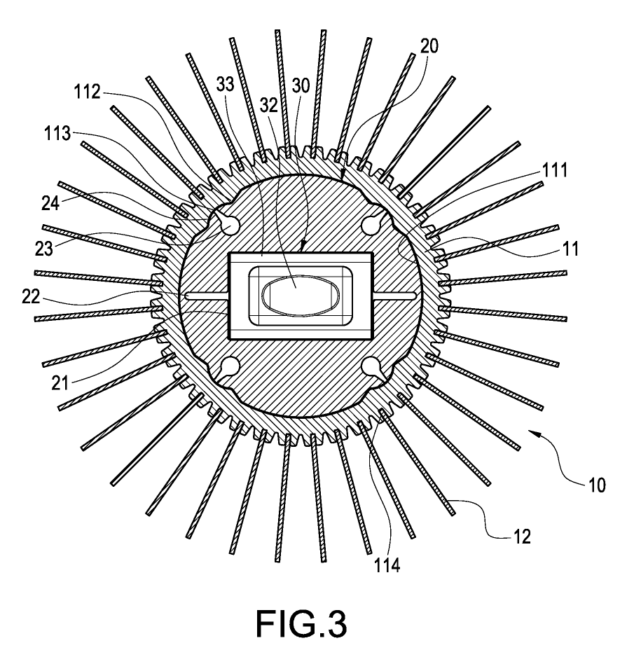

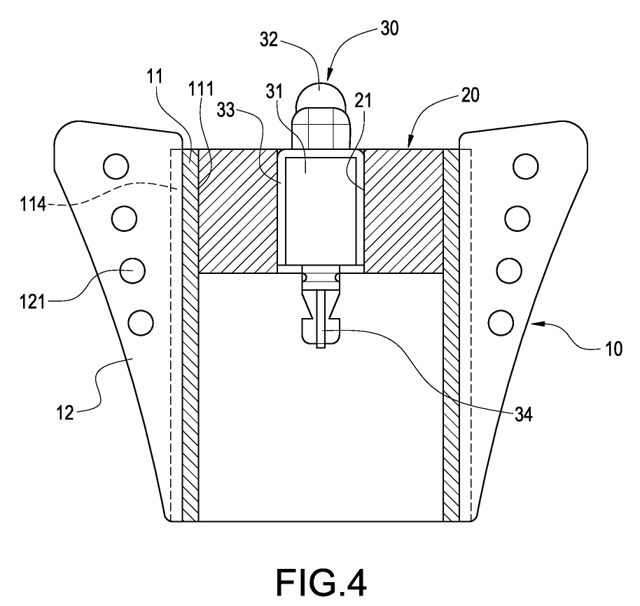

Please refer to FIG. 1 through FIG. 4. The invention is to provide an assembly structure for LED fixture, mainly including a cooling body 10, a thermally conductive body 20 and an LED module 30.

The cooling body 10 mainly includes a cylinder 11 and a plurality of cooling fins 12, all of which are made of materials of excellent cooling capability, such as, aluminum. At central position of the cylinder 11, there is a central hole 111, at an inner wall of which four sets of protrusive rails 112 are longitudinally formed. A groove path 113 is formed between each set of protrusive rails 112. In addition, at a peripheral wall of the cylinder 11, a plurality of insetting grooves 114 are arranged for providing each cooling fins 12 to be inset and forcedly combined therein. These cooling fins 12 are shown as a radial configuration and surround the exterior of the cylinder 11. Furthermore, in order to enhance the air ventilation between each cooling fins 12, a plurality of ventilation holes 121 are arranged thereon.

The thermally conductive body 20 is a cylindrical block formed integrally, which is made of materials of excellent cooling capability, such as, aluminum, and at a central position of which a rectangular opening 21 is arranged, at middles of two sides of which two groove gaps 22 are respectively arranged and communicated thereto. In addition, at a periphery of the thermally conductive body 20, there are four sectional grooves 23, at two sides of each of which two position stripes 24 inter-matched with the groove path 113 are formed respectively. When each sectional grooves 23 is pressed, a contracting deformation is generated, by which the thermally conductive body 20 is placed into the central hole 111 of the cylinder 11. Then, releasing the pressure from each sectional body 20 to function an elastic recovery, the thermally conductive body 20 is forcedly connected in the central hole 111 and formed an excellent configuration of thermal contact.

The LED module 30 mainly includes an insulation seat body 31, an LED 32, a thermally conductive piece 33 and two electrically conductive terminals 34. The LED 32 is fixed on top of the seat body 31. The thermally conductive piece 33 is configured as a “U” shape and fitted onto the seat body 31 to be thermally contacted with the LED 32. Each electrically conductive terminal 34 is electrically connected to the LED 32. When each groove gaps 22 is pressed, a contracting deformation is generated, by which the LED module can be closely contacted with the thermally conductive body 20 to form an excellent heat-conducting mechanism.

During assembly, the LED module 30 is first placed into the opening 21 of the thermally conductive body 20, then, using fixture (not shown in the figures) to clamp the peripheral wall of the thermally conductive body 20 to shrink the external size of the thermally conductive body 20. Next, both the thermally conductive body 20 and the LED module 30 are put into the central hole 111 of the cylinder 11. After the fixture has been taken out, each sectional grooves 23 is then elastically recovered. As a result, the LED module 30 and the thermally conductive body 20 are together combined in the central hole 111 of the cylinder 11 tightly.

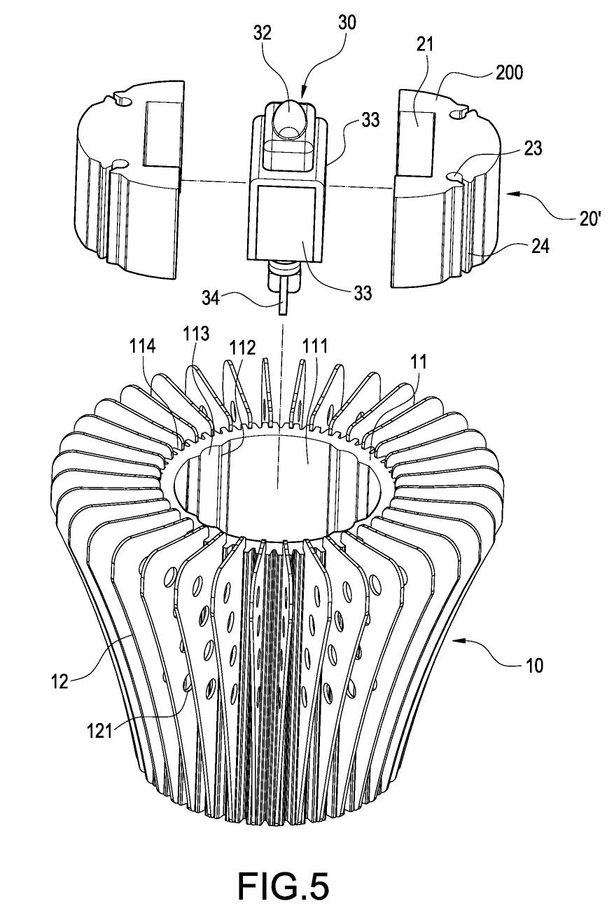

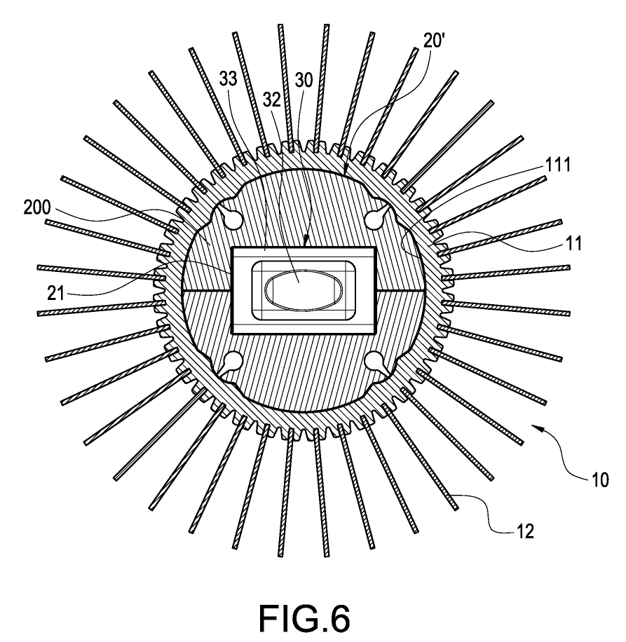

Please refer to FIG. 5 and FIG. 6, showing a second embodiment of the invention. Its structure is substantially same as that of the first embodiment. The differences between these two embodiments are described as the following. This thermally conductive body 20′ is mainly comprised of two semicircular blocks 200, at a center of which an opening 21 is arranged to surround the LED module 30. During assembly, the LED module 30 is first placed between the two semicircular blocks 200. Then, a fixture is used to clamp the peripheral wall of the thermally conductive body 20′. After the external size of the thermally conductive body 20′ is shrunk, the thermally conductive body 20′ and the LED 30 are together placed into the central hole 111 of the cylinder 11, whereby they are combined. By so doing, it is easy to enhance the assembly between the thermally conductive body 20′ and the LED module 30.

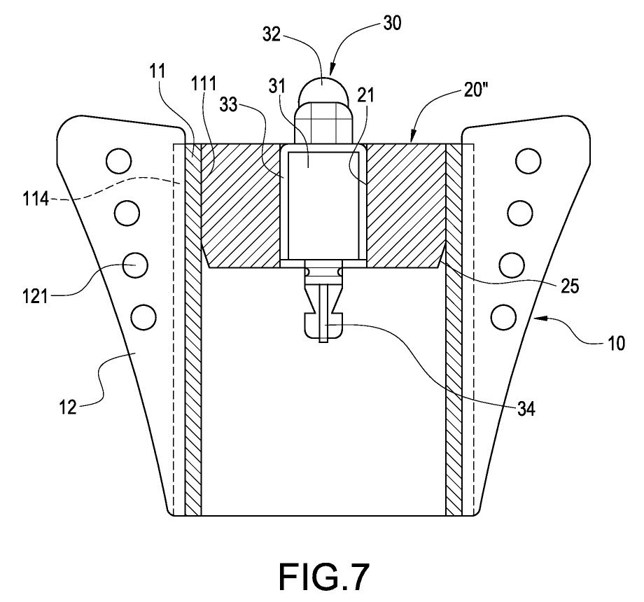

Please refer to FIG. 7, showing a third embodiment of the invention. This embodiment is mainly to form a chamfer 25 at the bottom part of the thermally conductive body 20″. Since the size of this chamfer 25 is smaller than that of the central hole 111 of the cylinder 11, the chamfer 25 of the thermally conductive body 20″ can be first inset into the central hole 111. Then, a press tool (not shown in the figures) can be directly used to press down the thermally conductive body 20″ to be forcedly inset into the central hole 111 and combined therewith tightly.

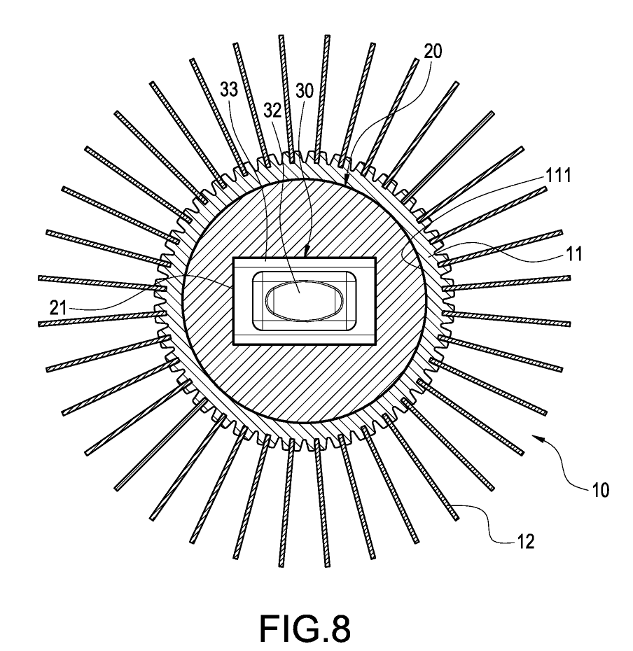

Please refer to FIG. 8, showing a fourth embodiment of the invention. This embodiment is mainly to design the opening 21 of the thermally conductive body 20 as a quadrilateral configuration, one width of which is approximately smaller than the width of the thermally conductive piece 33 of the LED module 30, such that a press tool can be used to squeeze the LED module 30 into the opening 21 of the thermally conductive body 20 by force, whereby both components are tightly combined.

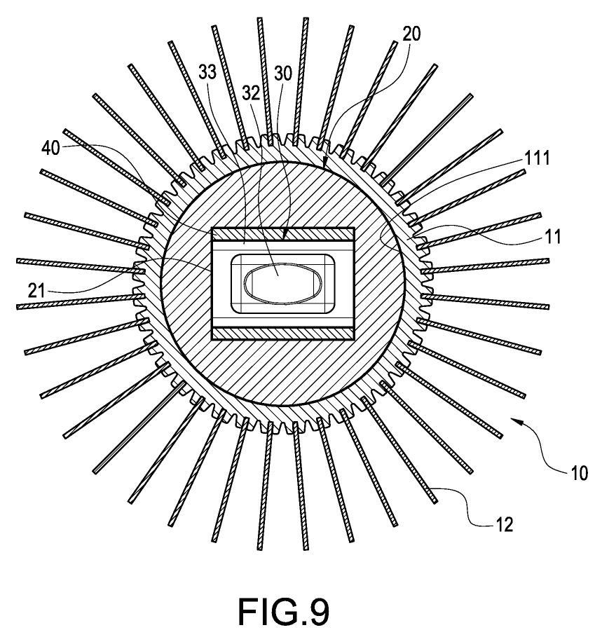

Please refer to FIG. 9, showing a fifth embodiment of the invention. This embodiment is mainly to design the opening 21 of the thermally conductive body 20 as a quadrilateral configuration as well, however, one width of which is designed to be larger than the width of the thermally conductive piece 33 of the LED module 30 such that, after the LED module 30 has been placed into the opening 21 of the thermally conductive body 20, a spacer 40 is inset into the gap formed between the LED module and the opening 21, whereby both components are tightly combined.

Accordingly, through the constitution of aforementioned assemblies, an assembly structure for LED fixture according to the invention is thus obtained.

Summarizing aforementioned description, the assembly structure is an indispensably design for LED fixture indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. An assembly structure for LED fixture, including:
a cooling body which includes a cylinder, a center of the cylinder has a central hole;
a thermally conductive body which is arranged an opening and a plurality of sectional grooves, each of the sectional grooves is elastically deformed to make the thermally conductive body forcedly arranged into the central hole and thermally contacted with the cylinder; and
an LED module,which is connected by passing through the opening of the thermally conductive body and includes a seat body, an LED fixed to the seat body and a thermally conductive piece fitted onto the seat body and thermally contacted with the thermally conductive body.

2. The assembly structure for LED fixture according to claim 1, wherein a plurality of protrusive rail sets are formed in an inner wall of the central hole, between each of which a groove path is formed and inter-matched with a position stripe by a wedging-and-clamping manner, and wherein two position stripes are formed respectively at two sides of each sectional grooves.

3. The assembly structure for LED fixture according to claim 1, wherein the cooling body further includes a plurality of cooling fins which are disposed in a radial configuration and fixed by inter-insetting into a plurality of insetting grooves arranged at a peripheral wall of the cylinder.

4. The assembly structure for LED fixture according to claim 3, wherein a plurality of ventilation holes are arranged on each cooling fins.

5. The assembly structure for LED fixture according to claim 1, wherein the thermally conductive body is integrally formed as a cylindrical block, and wherein two groove gaps are respectively arranged at two sides of the opening and communicated thereto.

6. The assembly structure for LED fixture according to claim 1, wherein the thermally conductive body is comprised of two semicircular blocks, and wherein the opening is arranged at a center of the two semicircular blocks.

7. The assembly structure for LED fixture according to claim 1, wherein an end side of the thermally conductive body formed in the cooling body is formed a chamfer.

8. An assembly structure for LED fixture, including
a cooling body which includes a cylinder, a center of the cylinder has a central hole;
a thermally conductive body which is forcedly arranged into the central hole and thermally contacted with the cylinder, and which has an opening at a center thereof, and
an LED module which is connected by passing through the opening of the thermally conductive body, and which includes a seat body, an LED fixed to the seat body and a thermally conductive piece fitted onto the seat body and thermally contacted with the thermally conductive body.

9. The assembly structure for LED fixture according to claim 8, wherein the cooling body further includes a plurality of cooling fins which are disposed in a radial configuration and fixed by inter-insetting into a plurality of insetting grooves arranged at a peripheral wall of the cylinder.

10. The assembly structure for LED fixture according to claim 9, wherein a plurality of ventilation holes are arranged on each cooling fins.

11. The assembly structure for LED fixture according to claim 8, wherein the opening is configured as a quadrilateral shape, a width of which is smaller than that of the LED module, thus, two components being able to be combined in a tightly fitting manner.

12. The assembly structure for LED fixture according to claim 8, further including a spacer, which is tightly wedged and clamped between the thermally conductive body and the thermally conductive piece, wherein the opening is configured as a quadrilateral shape, a width of which is larger than that of the LED module.
